(19) United States
(12) Patent Application Publication
(10) Pub. No.: US 2014/0297223 A1
(43) Pub. Date: Oct. 2, 2014

(54) METHOD FOR USING OPTICAL METROLOGY TO MONITOR CRITICAL DIMENSION UNIFORMITY

(71) Applicant: International Business Machines Corporation, Armonk, NY (US)

(72) Inventors: Michael S. Hibbs, Westford, VT (US); Ian P. Stobert, Hopewell Junction, NY (US); Jaione Tirapu-Azpiroz, Rio de Janeiro (BR)

(21) Appl. No.: 13/854,596

(22) Filed: Apr. 1, 2013

(51) Int. Cl. G01B 11/24

(52) U.S. Cl. CPC G01B 11/24
USPC 702/167; 702/155

(57) ABSTRACT

Various embodiments provide systems, computer program products and computer implemented methods. In some embodiments, the system includes a method of determining a characteristic of an optical mask. The method including: generating a first set of electromagnetic field (EMF) simulation data about the optical mask, using a first set of simulation criteria; determining a first correlation between optical metrology data about the optical mask and the first set of EMF simulation data; and determining the characteristic of the optical mask based upon the first correlation between the optical metrology data and the first set of EMF simulation data.

### FIELD

The subject matter disclosed herein relates generally to optical masks (or photo masks). More particularly, the subject matter disclosed relates to characterization of masks used in the formation of integrated circuits

### BACKGROUND

In general, characterization of optical mask profile, size and compositions is challenging, time consuming and resource consuming. Currently, optical mask profile metrology may utilize atomic force microscope (AFM) metrology. However, AFM methods are very time consuming and difficult to perform as AFM metrology requires small tips for measurement of small features or thin films and such small tips are expensive and often difficult to procure. AFM metrology can suffer from slow throughput, making fast measurement of a large number of sites challenging. By contrast, throughput using an aerial image measurement system (AIMS) is faster, and therefore AIMS methods allow for faster characterization of a large number of optical masks and mask sites than AFM-based metrology.

Scanning electron microscopes (SEM), are also conventionally used for optical mask metrology, and like AFM-based metrology, SEM-based metrology has limitations. Exact measurement using SEMs depends on metrology algorithms. SEMs introduce an offset relative to the physical size of the optical mask being measured and such an offset must be determined, often using AFM calibration. Other limitations of using SEMs include the fact that SEM measurements cannot always be made at the bottom of mask trenches, and errors in measurements can be introduced if sidewall angles are not exactly 90 degrees. Also, electron charging on mask edges, due to the use of the SEM, makes attaining accurate SEM-based metrology of optical masks difficult.

### BRIEF DESCRIPTION

Various aspects of the invention provide for characterization of optical masks using a correlation between optical metrology data and simulation data for an optical mask. Optical metrology as referred to herein, refers to electromagnetically measured or optically measured transmission of various diffraction orders. In some embodiments, a system includes processes for determining a characteristic of an optical mask, the method including: generating a first set of electromagnetic field (EMF) simulation data about the optical mask, using a first set of simulation criteria; determining a first correlation between optical metrology data about the optical mask and the first set of EMF simulation data using the at least one computing device; and determining the characteristic of the optical mask based upon the first correlation between the optical metrology data and the first set of EMF simulation data.

A first aspect provides a method of determining a characteristic of an optical mask, the method including: generating a first set of EMF simulation data about the optical mask, using a first set of simulation criteria; determining a first correlation between optical metrology data about the optical mask and the first set of EMF simulation data; and determining the characteristic of the optical mask based upon the first correlation between the optical metrology data and the first set of EMF simulation data.

A second aspect provides a system having at least one computing device configured to determine a characteristic of an optical mask by performing actions including: generating a first set of electromagnetic field (EMF) simulation data about the optical mask, using a first set of simulation criteria; determining a first correlation between optical metrology data about the optical mask and the first set of EMF simulation data; and determining the characteristic of the optical mask based upon the first correlation between the optical metrology data and the first set of EMF simulation data.

A third aspect provides a computer program product comprising program code stored on a computer-readable storage medium, which when executed by at least one computing device, enables the at least one computing device to implement a method of determining a characteristic of an optical mask by performing actions including: generating a first set of electromagnetic field (EMF) simulation data about the optical mask, using a first set of simulation criteria; determining a first correlation between optical metrology data about the optical mask and the first set of EMF simulation data using the at least one computing device; and determining the characteristic of the optical mask based upon the first correlation between the optical metrology data and the first set of EMF simulation data.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1A shows a flow diagram illustrating a method according to various embodiments.

FIG. 1B shows a flow diagram illustrating optional processes in a method according to various embodiments.

FIG. 2 shows a flow diagram illustrating a method according to various embodiments.

FIG. 3 shows a flow diagram illustrating a method according to various embodiments.

FIG. 4 shows a conventional mask system.

FIG. 5 shows exemplary data according to embodiments of the inventive concepts

FIG. 6 shows exemplary data according to embodiments of the inventive concepts

FIGS. 7A,7B and 7C show exemplary data according to embodiments of the inventive concepts.

FIG. 8 shows an illustrative environment including a system according to embodiments of the inventive concepts.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The subject matter disclosed herein relates generally to characterization of optical masks (or photomasks) using an aerial image metrology system (AIMS). More specifically, the disclosure provided herein relates to methods of characterizing optical masks by correlating a metrology of the transmission from an optical mask measured using AIMS with simulation data, for example, using rigorous Maxwell equations, to predict expected transmission through the optical mask.

As described herein, problems regarding characterization of optical mask profile, size and composition include that such characterization is challenging, time consuming and resource consuming. Prior attempts at optical mask profile metrology utilizing atomic force microscopes (AFM) were very time consuming and difficult to perform. This is at least in part because AFM metrology requires small tips for measurement of small features of thin films and such small tips are expensive and often difficult to procure. Further problems include that AFM metrology suffers from very slow throughput, making fast measurement of a large number of sites impossible. By contrast, throughput using AIMS is faster, and therefore AIMS methods allow for faster characterization of a large number of optical masks and masks sites than AFM-based metrology.

Scanning electron microscopes (SEM) are conventionally used to characterize optical masks. Prior attempts of characterizing optical masks using SEM-based metrology (like attempts using AFM-based metrology) also have encountered limitations. Such limitations include that exact measurement using SEMs depends on metrology algorithms, as SEMs introduce an offset relative to the actual physical size of the optical mask being measured and such an offset must be determined, often using AFM calibration. Other limitations of SEM-based metrology include that SEM measurements are not always made at the bottom of optical mask trenches and that errors can be introduced if sidewall angles are not exactly 90 degrees. Also, electron charging on mask edges, due to the use of the SEM, makes SEM-based metrology of optical masks difficult and inaccurate.

As differentiated from conventional attempts at optical mask metrology, various embodiments described herein allow for faster accurate determination of optical mask characteristics.

According to various aspects described herein, optical metrology, used here to describe the optically measured transmission of various diffraction orders through the optical mask, is performed using a pattern, or a set of patterns, which may include a set of opaque features over a transparent substrate or clear openings etched through the thickness of the opaque mask layer over the substrate, set across areas of an optical mask in a stencil-like fashion, and projecting light through the pattern with an illumination system. The diffraction from these patterns is measured with techniques capable of capturing the electromagnetic energy diffracted by the patterns. Such energy propagates as separate beams in various directions when the patterns are periodic. This technique may include, but is not limited to use of, optical microscopes, AIMS tools or electromagnetic detectors. The results from the optical metrology (electromagnetic measurements of the transmission of various diffraction orders) are then compared to accurate and rigorous electromagnetic simulations of the diffraction conducted using the same patterns, to the extent of the known pattern characteristics, but repeating said rigorous simulations for the same set of patterns where the value of each unknown parameters is varied within a range of possible values. Any deviation of the measurements relative to the simulations is used to deduce unknown parameters, critical dimensions (CD) or other characteristics of the optical masks (herein generally referred to as “characteristics”) and/or to monitor variations of such mask characteristics across an area of the mask. For instance, the results from rigorous simulations of the transmission through said set of mask patterns where the value of an unknown parameter, such as mask pattern linewidth bias, is varied across a range of possible values, is compared to electromagnetic measurements of the transmission through said set of mask patterns. The deviation of the simulation results from the measurements is computed for each case of unknown parameter value used during the simulations. Finally, the value of the unknown parameter that produces the minimum deviation, or best correlation, between simulation data and measured data is identified as the most optimum value for said mask unknown characteristic, such as mask linewidth bias. Alternatively, the electromagnetic measurements taken at a predefined location can be used as a reference to monitor variations of certain mask parameters across an area of the mask. This alternative technique can be used to characterize and/or monitor various mask characteristics without comparison to simulated data.

The techniques according to various aspects may be useful in characterizing areas of a mask where other metrology techniques cannot operate. For example, SEM may not operate due to charging, or other effects that affect the accuracy of SEM metrology.

According to some particular aspects the AIMS measurement used in the optical metrology of mask transmission uses only the 0^{th}-order (zeroth-order) diffraction efficiency in order to determine many details about precise mask size, mask profile and mask composition in the form of optical constants of the mask materials without the complexity introduced by higher order diffraction. Under these various particular aspects the optics are adjusted to detect only 0^{th}-order (zeroth-order) diffraction (from the pattern or grating placed over the optical mask), for example by spatial filtering of higher diffraction orders through a reduction of the entrance pupil numerical aperture of the imaging system. Also AIMS metrology of an optical mask, alone, is beneficial as it avoids negative effects that would otherwise be introduced by resist chemistry on the wafers.

Under various aspects, in order to determine unknown characteristics of an optical mask, optically measured transmission of various diffraction orders from an optical mask is used to attain a benchmark and optically measured transmission data are correlated with data from rigorous EMF simulations. Comparison of the optically measured transmission results with the EMF simulations enables accuracy in deducing mask linewidths, for instance, down to about 0.1 to 0.2 nm at wafer scale. Also, in order to reduce noise in measurements and ensure against systematic errors in the data collected or the model used, averaging across a range of grating pitches may be implemented.

According to various embodiments, analysis of correlations between EMF simulations and optically measured transmission of various diffraction orders can be used to determine mask composition, including thickness and mask optical constants. Also, if such mask composition data are known, the comparison of simulation data and AIMS metrology data may be used to determine exact mask pattern size or mask topography, including sidewall angle (SWA). Other uses include the determination of changes in mask thickness as a function of time. Also, if optical mask pattern size and topography are known, for example through AFM measurements (or from information acquired from the optical mask supplier), it is possible, according to various aspects of the invention, to reverse engineer optical mask composition (i.e., thickness and/or optical constants). Additionally, complex inverse scattering algorithms can be devised to estimate a combination of unknown optical mask characteristics from the diffraction efficiency differences between simulation and AIMS measurements for a combination of optical mask patterns and polarization options.

In various embodiments, the gratings used to take AIMS measurements may be selected from, one-dimensional (1D) gratings, for example, of equal line and space ratio, although the use of other gratings or grating line and space ratios are within the scope of this disclosure. Various alternate embodiments include arbitrarily-spaced grating line and space ratios. In general, if the diffraction response from any set of structures, for example, periodic structures, both 1D and two-dimensional (2D), is understood, based on electromagnetic theory or numerical simulations, such structures may also be used to determine or monitor optical mask characteristics.

It should be noted that methods to optically measure transmission through an optical mask using other electromagnetic energy detectors may be used to measure 0^{th}-order (zeroth-order) diffraction efficiency and such use is within the scope of this disclosure.

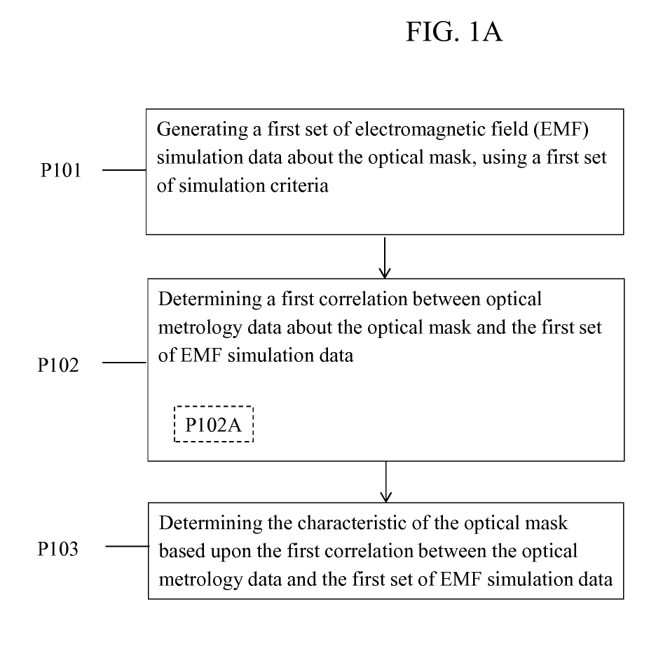

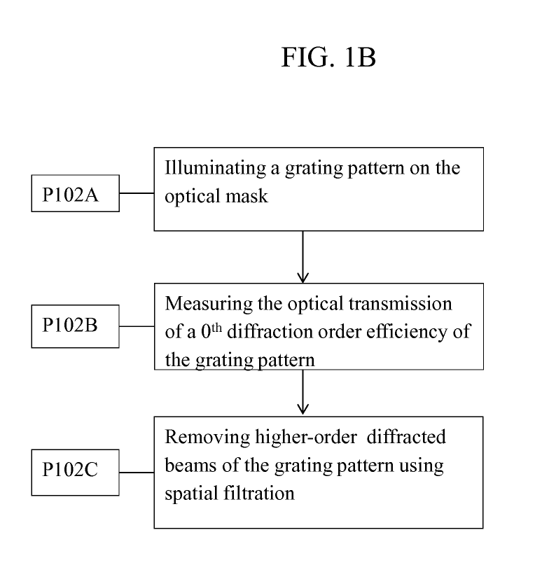

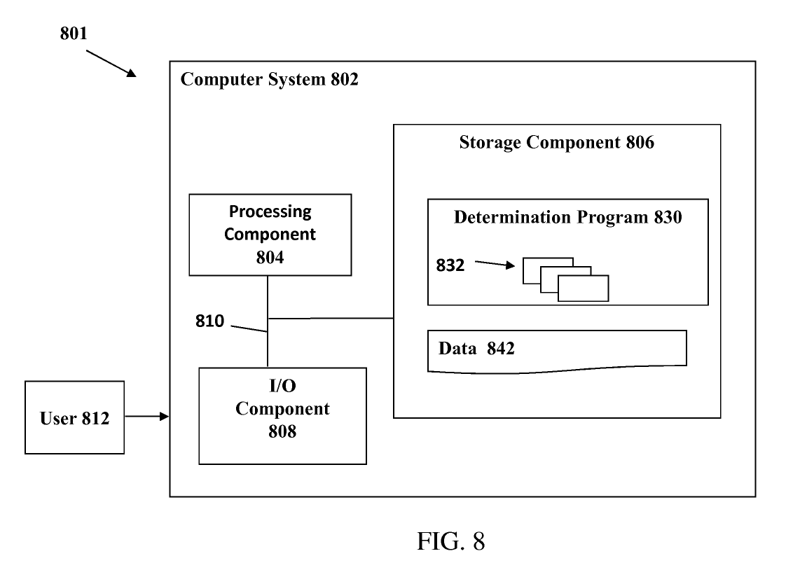

Turning now to FIG. 1A, a flow diagram is shown illustrating a method according to various embodiments. FIG. 1A illustrates processes in a method of determining a characteristic of an optical mask. In various embodiments, the method is performed using at least one computing device (FIG. 8). Process P101 includes generating a first set of electromagnetic field (EMF) simulation data about the optical mask, using a first set of simulation criteria. Such criteria may include the refractive behavior using a set of gratings of different pitch or different line-space ratio. The first set of EMF simulation data may include the computation of the electric and magnetic fields amplitude and phase that propagate through the optical mask where said set of patterns have been etched through the mask absorber film, when this optical mask is illuminated on one side with a light source. These EMF fields transmitted through the mask pattern are used to deduce the diffraction efficiency at various propagation directions (various diffraction orders) from each mask pattern within said set of mask patterns at the specific wavelength, incident angle and polarization as defined by the source incident illumination. The diffraction efficiency at various propagation directions can be computed through the Fourier Transform of the simulated EMF fields according to standard far field diffraction theory, thus representing a first set of simulation criteria.

Process P102 includes determining a first correlation between optical metrology data about the optical mask and the first set of EMF simulation data. The correlation determined may be related to a deviation of electromagnetic measurements (using an optical microscope, AIMS, etc.) relative to simulations. Such correlation may correspond to the root mean squared differences between measured and simulated diffraction efficiency at one or various diffraction propagation directions, for one mask pattern or a set of mask patterns, and/or at one case of illumination conditions or at various cases of illumination conditions, where illumination conditions refer to specific source wavelength, illumination angle and/or polarization. The final root mean squared difference can be computed as a combination of the root mean squared difference at the various conditions described above.

Process P103 includes determining the characteristic of the optical mask based upon the first correlation between the optical metrology data and the first set of EMF simulation data. The characteristic may include an unknown parameter of the optical mask. Such parameters may include optical mask composition (including thickness or mask optical constants), optical mask pattern size, optical mask profile topography, including side wall angle (SWA), or a critical dimension of the optical mask. EMF simulation data is repeated for the same set of mask patterns but where the exact value of the unknown mask characteristic, for instance mask linewidth bias, is varied within a range of possible values. A first correlation value is computed between each set of EMF simulation data with each value of the unknown mask characteristic and the optical metrology data as described in relation to process P102. The final mask characteristic, such as mask linewidth bias, is identified as the parameter value that produces the best first correlation between optical metrology and simulated data.

FIG. 1B illustrates exemplary, optional processes which may be used for acquiring optical metrology data. Optional process P102A includes illuminating a grating pattern or set of grating patterns on a mask. According to various aspects, the grating may be any grating appropriate for optical metrology. The grating may, for example, be one dimensional and further the grating may be described by having equal line space ratio. Various embodiments may use other gratings, including, but not limited to two dimensional gratings, for example gratings having square openings.

Optional process P102B includes measuring the optical transmission of a 0^{th}-diffraction order efficiency of the grating pattern.

Optional process P102C includes removing higher order diffracted beams of the grating pattern using spatial filtering. When optical metrology is being done using an Aerial Image Measurement System or AIMS, for instance, only the electromagnetic waves diffracted from the photomask (optical mask) and propagating with direction cosines confined within the cone of angles subtended by the numerical aperture (NA) of the optical system will be captured. As such, it is possible to select only the lower order diffraction by adjusting the lens NA. In addition, when using AIMS for optical metrology, the illumination of the mask should be selected normal to the mask surface, that is, as close to coherent illumination propagating along the direction perpendicular to the mask surface as possible, such that the 0^{th}-order diffraction efficiency propagates through the center of the entrance pupil lens, reducing the chances of higher order diffracted beams leaking through the imaging system. Finally, the mask patterns can also be designed such that they diffract higher order diffracted beams with propagation angles larger than the optical system numerical aperture, hence facilitating their exclusion from the system.

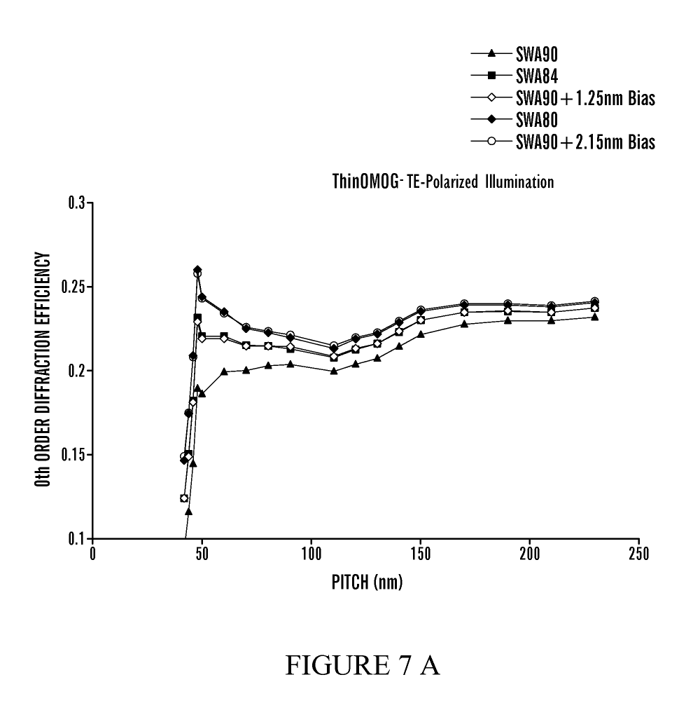

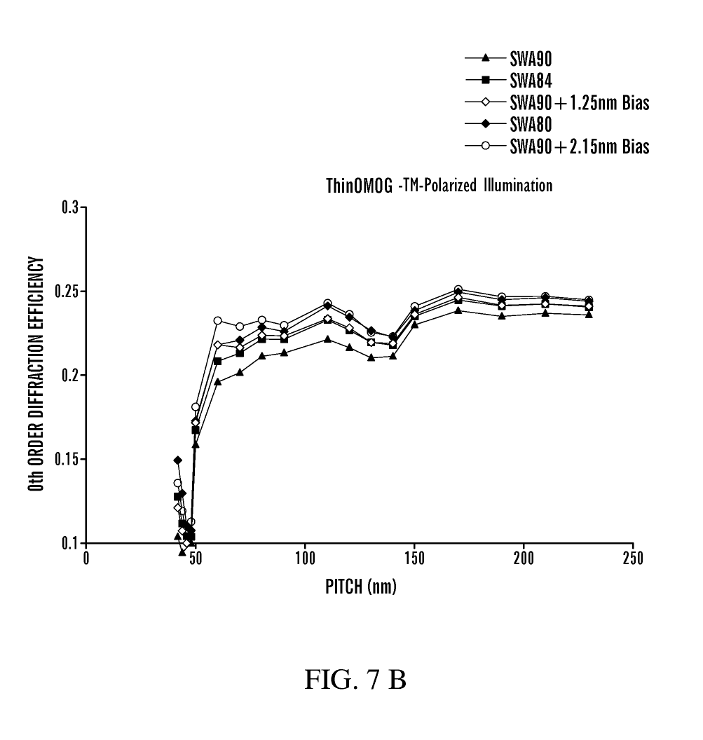

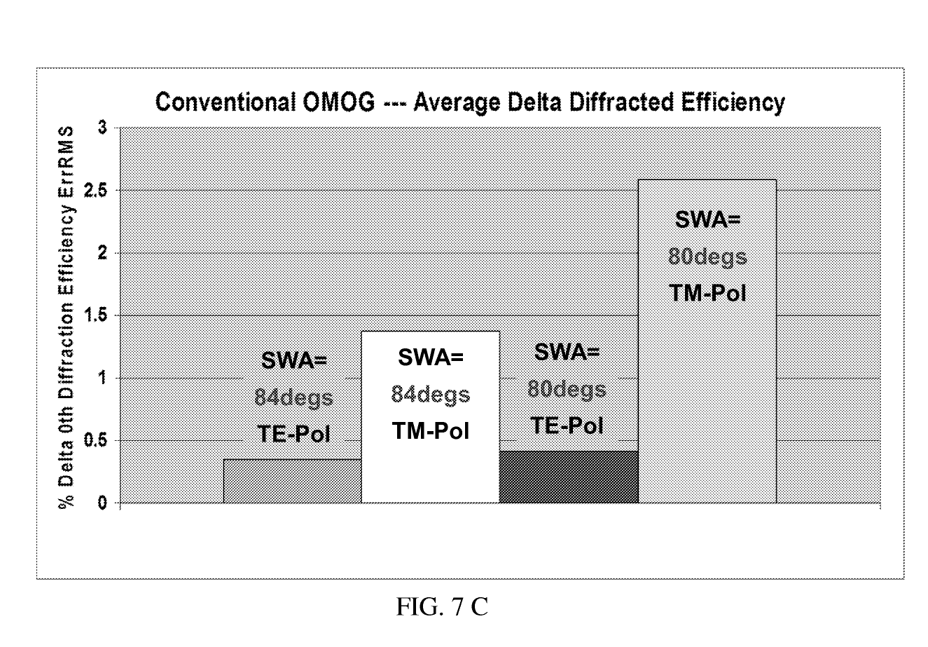

The characteristic of the optical mask determined include, but are not limited to linewidth, also known herein as critical dimension (CD) of the optical mask pattern, pattern size of the optical mask, critical dimension bias, a sidewall angle of the optical mask topography, mask material composition such as optical constants or thickness, a topography profile of the optical mask or any combination of these characteristics. Referring to FIG. 7B, process P102 could select to illuminate the mask with linearly polarized light parallel to the x-axis or TM polarized light. The transmission of light through the mask patterns shows a stronger dependency on the mask topography side wall angle (SWA) for x-axis polarized light perpendicular to a hypothetical 90 degrees mask sidewall (TM polarization), than for y-polarized light parallel to the mask profile sidewalls (TE polarization). Correlation data between simulated and measured transmission data from the optical mask with TM-polarized light can then be used to deduce mask profile SWA information or, to deduce both mask CD and SWA information by performing EMF simulations of the transmission through the optical mask patterns with enough combined variations of CD bias and SWA parameters to obtain the optimum values that maximize correlation between simulated and measured data.

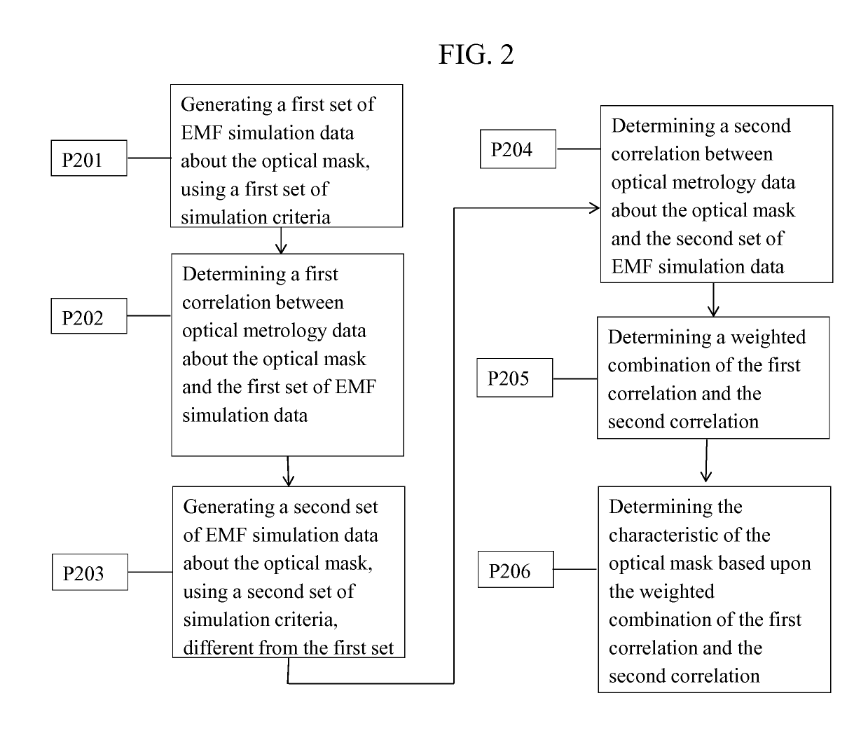

Referring now to FIG. 2, a method for characterizing an optical mask using multiple sets of EMF simulations is illustrated. Process P201 includes generating a first set of EMF simulation data about the optical mask, using a first set of simulation criteria. EMF simulation data is described above.

After performing process P201, the method includes performing process P202. Process P202 includes determining a first correlation between optical metrology data about the optical mask and the first set of EMF simulation data. The first correlation may be determined using methods as described above with respect to process P102.

After performing process P202, the method includes performing process P203. Process P203 includes generating a second set of EMF simulation data about the optical mask, using a second set of simulation criteria, different from the first set of simulation criteria. Next, process P204 includes determining a second correlation between optical metrology data about the optical mask and the second set of EMF simulation data. The second correlation may be determined using methods as described above with respect to process P102 or P202. For instance, a first correlation between EMF simulation and optical metrology can involve illuminating the mask at a predetermined set of conditions, for example illuminating the mask with linearly polarized light parallel to the x-axis, while the second correlation can involve a different set of illumination conditions such as light polarized along the y-axis.

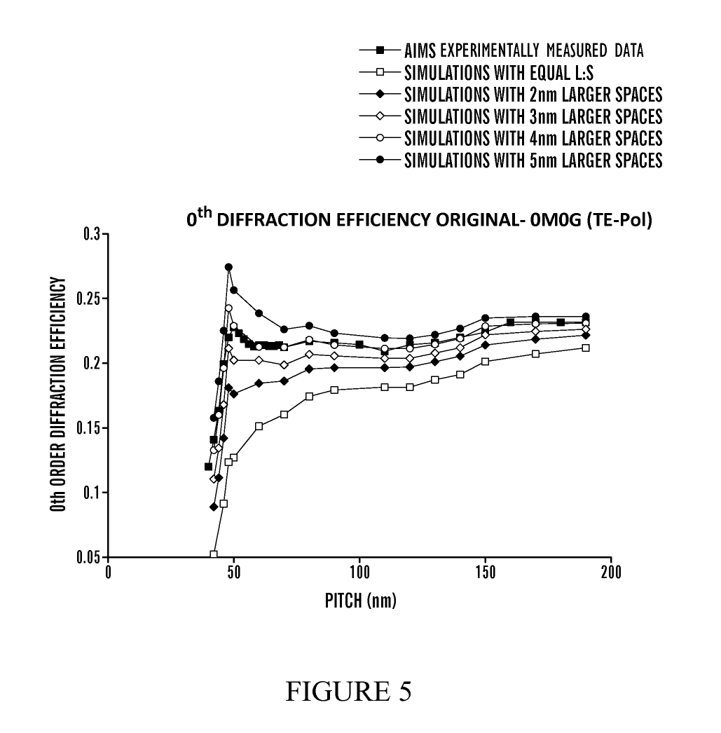

Next, process P205 includes determining a weighted combination of the first correlation and the second correlation. An exemplary determination of weighted combination of the first correlation and the second correlation computed for two independent, linearly polarized and orthogonal illumination conditions. Examples of this concept are described below in reference to FIGS. 5-8 and are not included here for the sake of brevity. Process P206 includes determining the characteristic of the optical mask based upon the weighted combination of the first correlation and the second correlation. An example of such a determination is described hereinabove, with respect to process P103, where the first computed correlation with linearly polarized illumination parallel to the mask profile sidewalls is not sufficient to deduce information about the sidewall angle, but when combined with the second computed correlation with linearly polarized illumination perpendicular to the mask profile sidewalls, the results become a signature function of the sidewall angle and can be used to deduce this mask characteristic. Referring to FIG. 7C, this third combined correlation value can then be used to deduce mask profile SWA information or, to deduce both mask CD and SWA information by performing EMF simulations of the transmission through the optical mask patterns with enough variations of CD bias and SWA parameters to obtain the optimum values that maximize correlation between simulated and measured data. Alternatively, the first set of simulation data can be combined with the second set of simulation data to create one single set of simulation data, while in parallel, the first set of measured data is combined with the second set of measured data to create a single set of measured data from where to extract a single correlation value between all simulation and all measured data. This single value of correlation is then used to extract mask characteristics such as mask CD bias, SWA or a combination of both. One skilled in the art understands that these processes may be iteratively repeated more than twice in order to characterize the optical mask. In addition, the process can be performed in steps where a first set of simulation data and measured data are used to determine a first correlation value and to determine a first mask characteristic. For instance using TE polarized illumination which is not largely affected by mask profile SWA to deduce mask linewidth bias by performing EMF simulations with varying values of linewidth bias. Once an optimum mask linewidth bias is deduced, a second set of simulation data and measured data are used to determine a second correlation value to extract a second mask characteristic. For instance, simulation and measured data with TM polarized illumination, which shows a stronger dependency on mask profile SWA, can be used to deduce mask profile SWA at a fixed linewidth bias value by performing EMF simulations with varying values of SWA until the optimum correlation is achieved. And one skilled in the art will understand that a difference between first and second correlations may be zero.

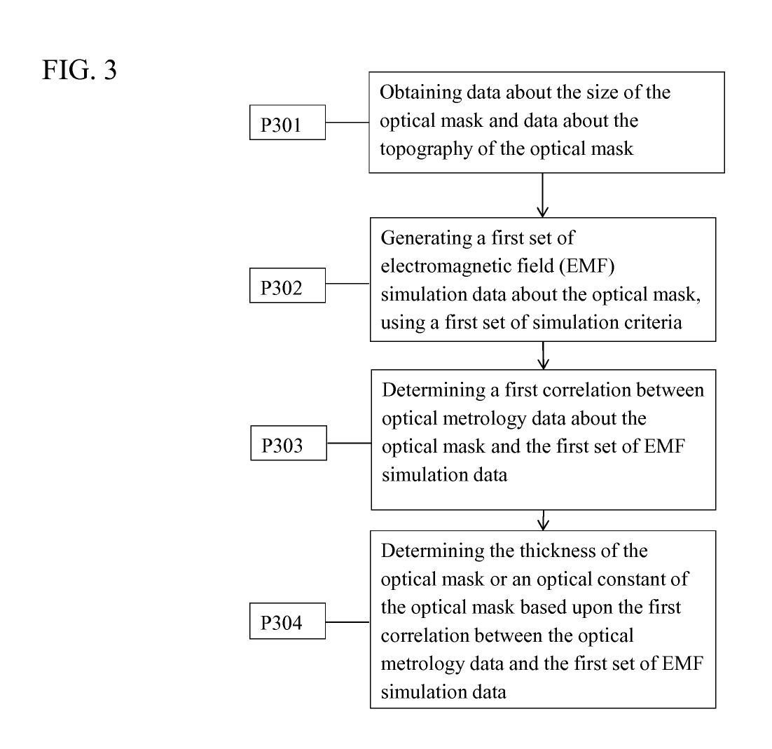

Referring now to FIG. 3, a method for characterizing the thickness of an optical mask, or an optical constant of an optical mask is described. Process P301 includes obtaining data about the size of the patterns placed or etched on the optical mask and data about the profile of the topography of the optical mask, such as sidewall angle. Such data may be acquired by measurement, for example using the optical metrology described herein, or directly from the manufacturer of the mask, or by any other means.

Continuing with the description of this embodiment, process P302 includes generating a first set of electromagnetic field (EMF) simulation data about the optical mask, using a first set of simulation criteria. Such simulation data and simulation criteria are described above. Once pattern size and topography data are acquired in process P301, process P303 may be performed. Process P303 includes determining a first correlation between optically measured transmission of various diffraction orders from the optical mask and the first set of EMF simulation data. Process 303A may be performed using at least one computing device. Process P304 includes determining the thickness of the optical mask or an optical constant of the optical mask based upon the first correlation between the measured transmission data from the optical mask and the first set of EMF simulation data. Examples of determining characteristics of an optical mask based on simulation data and optical metrology data are shown below but are not repeated throughout for the sake of brevity.

Various particular embodiments of the methods described herein can be used to deduce AFM-SEM offset. As described above, measurement using SEMs introduces an offset relative to the physical size of the patterns on the optical mask being measured and such an offset is conventionally determined using AFM calibration. Such AFM calibration may be avoided using embodiments such as described below.

Top-down SEM metrology relies on capturing electrons scattered back from the surface of the object being measured. This approach introduces an offset between the physical position of the object source and the position of the surface as measured by the SEM. For line widths, this means that the SEM measures spaces as being smaller than they really are by an offset or bias that can be calibrated with the aid of AFM measurements for the same mask pattern, assuming that accurate measurements are taken by the AFM.

The AFM-to-SEM offset is also observed when measuring optical masks and the inventive concepts are useful in determining this offset. The masks used in the collection of data for this example are conventional, thick optical masks made of opaque molybdenum-silicon (MoSi) on glass (OMOG). The effect of the offset results in a gap between the AIMS measured 0^{th}-order diffraction efficiency and simulation data. When simulating the 0^{th}-order diffraction efficiency with mask pattern size as measured by the SEM, even when all other mask properties are known and accurate, the simulations do not match the 0^{th}-order as measured by AIMS.

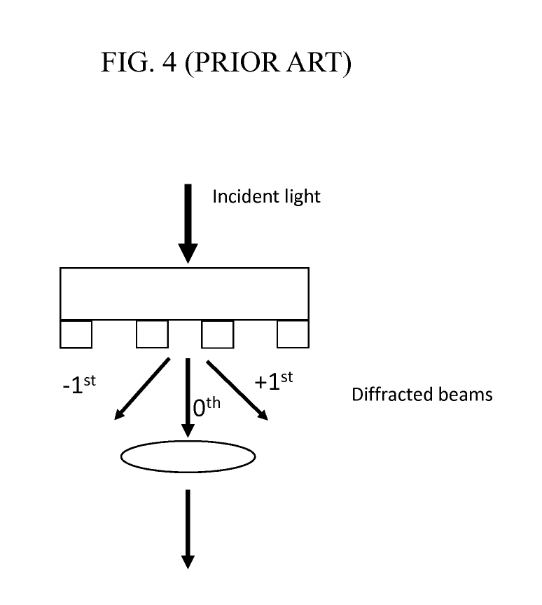

FIG. 4 illustrates a conventional grating pattern allowing 0^{th}-order and 1^{st}-order diffraction used in various aspects of the invention. When simulating the same gratings as used when optically measuring the transmission of various diffraction orders from the optical mask, but using mask spaces larger than the SEM measurements by as much as 4 nm per critical dimension (CD), e.g., at wafer scale, 4 nm per CD equals 16 nm larger CD at the mask, the simulations more accurately predict the measurements of the transmission through the optical mask. See FIG. 5 which illustrates data curves for four different simulations, each having different simulation criteria, plotted against measured AIMS data.

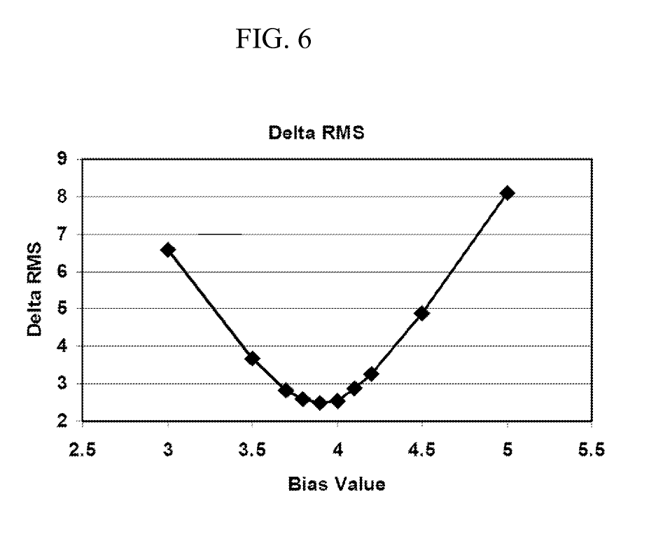

Next, computing a root mean square (RMS) difference between the simulations and measurements, plotted as a percent change from the simulated ideal thin mask approximation (TMA) value for the 0^{th}-order diffraction efficiency of 0.25, a more accurate value of SEM offset for the mask was predicted. FIG. 6 illustrates that the measured minimum RMS difference is 3.9 nm/CD at wafer scale, or 15.6 nm at mask scale. This offset was confirmed using direct comparisons of conventional AFM and SEM measurement.

Various other embodiments include deducing an optical mask sidewall angle (SWA). An example of deducing SWA is described herein, immediately below.

Differences between AIMS measurement data and simulation-derived data can be used to estimate SWA of optical mask topography. This example uses known mask thickness, mask optical constants and absorber width and determines SWA changes using differences in 0^{th}-order diffraction efficiency.

Once the simulation data is collected, in this case for the simulated transmission through mask patterns with topography sidewalls of angles 80 degrees, 84 degrees and 90 degrees, transverse electric (TE-) field-polarized illumination and transverse magnetic (TM-) field-polarized illumination can be used to determine the sidewall angle of an optical mask topography profile. When used to illuminate the same object, TE- and TM-polarized illumination show different transmission responses due to the differences in boundary conditions. When TE-polarized incident illumination is used, that is with the electric field parallel to the mask profile wall, biasing the optical mask CD can introduce an effect in the 0^{th}-order diffracted efficiency that is equivalent to the effect of changing the SWA. However, when TM-polarized incident illumination is used, the incident electric field is perpendicular to a hypothetical 90-degree profile wall and the boundary conditions depend on the SWA, therefore a simple offset cannot be determined across all pitches that introduces an effect in the 0^{th}-order diffracted efficiency equivalent to changing the SWA. That is, the transmission from the optical mask with TM-polarized incident illumination is affected by SWA such that a single offset can generally not be used to reproduce a similar effect using different sized gratings in AIMS measurements.

The different diffraction response between TM- and TE-polarized incident illumination can be used to separate the effects of a change in optical mask CD and a change in mask SWA. The optimum mask offset (bias) is that which can be applied to the simulations using a mask profile of 90 degrees to minimize the differences between simulation data and AIMS measurements for TE-polarized incident illumination. The average difference in the 0^{th}-order diffraction efficiency was calculated with the same offset applied to the simulated mask CD with 90 degree SWA but using instead the measurements made using TM-polarized incident illumination. Referring to FIG. 7C, said average difference between simulated and measured 0^{th}-order diffracted efficiency is a function of the SWA, increasing the difference as the SWA moves further from the 90 degrees reference. As a result, this relation between the transmission from the optical with TM-polarized illumination and the SWA can be used to estimate the mask profile SWA from the calculated average differences in the measurements made for the TM-polarized incident illumination.

Simulated 0^{th}-order diffraction efficiency from TE- and TM-polarized incident illumination for optical masks or profile SWA equal to 90 degrees, 84 degrees and 80 degrees are plotted in FIGS. 7A and 7B, together with simulated 0^{th}-order diffraction efficiency from mask with 90 degrees SWA with a CD bias applied to the mask linewidth. FIG. 7C shows the mean root squared error for both TE-polarized and TM-polarized illumination, averaged across a set of mask line-space pitches, between the simulated transmission from an optical mask with a 90 degrees SWA where the optimum CD bias that minimizes the error RMS for the case of TE-polarized illumination has been applied, as compared to the simulated transmission from an optical mask with a 84 degree SWA and 80 degree SWA. It can be observed that the error RMS remains approximately constant and equal to the minimum possible for the TE-polarized illumination case, regardless of the mask profile SWA when the optimum CD bias is applied. However this same error RMS is much larger and increases with SWA for the case of TM-polarized illumination.

FIG. 8 depicts an illustrative environment 800 for determining a characteristic of an optical mask. To this extent, the environment 800 includes a computer system 802 that can perform a process described herein in order to characterize an optical mask. In particular, the computer system 802 is shown as including a determination program 830, which makes computer system 802 operable to handle characterizing an optical mask by performing any/all of the processes described herein and implementing any/all of the embodiments described herein.

The computer system 802 is shown including a processing component 804 (e.g., one or more processors), a storage component 806 (e.g., a storage hierarchy), an input/output (I/O) component 808 (e.g., one or more I/O interfaces and/or devices), and a communications pathway 810. In general, the processing component 804 executes program code, such as the determination program 830, which is at least partially fixed in the storage component 806. While executing program code, the processing component 804 can process data, which can result in reading and/or writing transformed data from/to the storage component 806 and/or the I/O component 808 for further processing. The pathway 810 provides a communications link between each of the components in the computer system 802. The I/O component 808 can comprise one or more human I/O devices, which enable a human user 812 to interact with the computer system 802 and/or one or more communications devices to enable a system user 812 to communicate with the computer system 802 using any type of communications link. To this extent, determination program 830 can manage a set of interfaces (e.g., graphical user interface(s), application program interface, etc.) that enable human and/or system users 812 to interact with determination program 130. Further, the determination program 830 can manage (e.g., store, retrieve, create, manipulate, organize, present, etc.) data, such as post-OPC data 842, etc., using any solution.

In any event, the computer system 802 can comprise one or more general purpose computing articles of manufacture (e.g., computing devices) capable of executing program code, such as the determination program 830, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the lithography set point location program 830 can be embodied as any combination of system software and/or application software.

Further, the determination program 830 can be implemented using a set of modules 832. In this case, a module 832 can enable the computer system 802 to perform a set of tasks used by the determination program 830, and can be separately developed and/or implemented apart from other portions of the determination program 830. As used herein, the term “component” means any configuration of hardware, with or without software, which implements the functionality described in conjunction therewith using any solution, while the term “module” means program code that enables the computer system 802 to implement the functionality described in conjunction therewith using any solution. When fixed in a storage component 806 of a computer system 802 that includes a processing component 804, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 802.

When the computer system 802 comprises multiple computing devices, each computing device may have only a portion of determination program 830 fixed thereon (e.g., one or more modules 832). However, it is understood that the computer system 802 and determination program 830 are only representative of various possible equivalent computer systems that may perform a process described herein. To this extent, in other embodiments, the functionality provided by the computer system 802 and determination program 830 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 802 includes multiple computing devices, the computing devices can communicate over any type of communications link. Further, while performing a process described herein, the computer system 802 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 802 can obtain or provide data, such data 842 using any solution. For example, the computer system 802 can generate and/or be used to generate data 842, retrieve data 842, from one or more data stores, receive data 842 a, from another system, send 842 to another system, etc.

While shown and described herein as a method and system for determining a characteristic of an optical mask using optical metrology and simulation data, it is understood that aspects of the invention further provide various alternative embodiments. For example, in one embodiment, the invention provides a computer program fixed in at least one computer-readable medium, which when executed, enables a computer system to perform a method of determining a characteristic of an optical mask. To this extent, the computer-readable medium includes program code, such as characteristic determining system 802 (FIG. 8), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of determining a characteristic of an optical mask using optical metrology data and simulation data. In this case, a computer system, such as computer system 802 (FIG. 8), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to characterize an optical mask as described herein. In this case, the service provider can manage (e.g., create, maintain, support, etc.) a computer system, such as computer system 802 (FIG. 8), that performs a process described herein for one or more customers. In return, the service provider can receive payment from the customer(s) under a subscription and/or fee agreement, receive payment from the sale of advertising to one or more third parties, and/or the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of determining a characteristic of an optical mask, the method comprising:
generating a first set of electromagnetic field (EMF) simulation data about the optical mask, using a first set of simulation criteria;
determining a first correlation between optical metrology data about the optical mask and the first set of EMF simulation data; and
determining the characteristic of the optical mask based upon the first correlation between the optical metrology data and the first set of EMF simulation data.

2. The method of claim 1, further comprising:
generating a second set of EMF simulation data for the optical mask, using a second set of simulation criteria, the second set of simulation criteria different from the first set of simulation criteria;
determining a second correlation between the second set of EMF simulation data and the optical metrology data;
determining a weighted combination of the first correlation and the second correlation; and
determining the characteristic of the optical mask based upon the weighted combination of the first correlation and the second correlation.

3. The method of claim 1, wherein the characteristic of the optical mask includes at least one of a pattern size of the optical mask, an optical property of the mask, a sidewall angle of the optical mask or a topography profile property of the optical mask.

4. The method of claim 1, further comprising obtaining of the optical metrology data, including:
illuminating a grating pattern on the optical mask;
measuring optical transmission of a zeroth diffraction order efficiency of the grating pattern and
removing higher order diffracted beams of the grating pattern using spatial filtration.

5. The method of claim 4, wherein the grating includes a one-dimensional grating with an equal line-space ratio.

6. The method of claim 1, further comprising;
obtaining data about a pattern size of the optical mask and data about a topography of the optical mask,
wherein the determining of the characteristic includes determining at least one of a thickness of the optical mask or an optical constant of the optical mask.

7. A system comprising:
at least one computing device configured to determine a characteristic of an optical mask by performing actions including:
generating a first set of electromagnetic field (EMF) simulation data about the optical mask, using a first set of simulation criteria;
determining a first correlation between optical metrology data about the optical mask and the first set of EMF simulation data; and
determining the characteristic of the optical mask based upon the first correlation between the optical metrology data and the first set of EMF simulation data.

8. The system of claim 7, the at least one computing device further configured to perform actions including:
generating a second set of EMF simulation data for the optical mask, using a second set of simulation criteria, the second set of simulation criteria different from the first set of simulation criteria;
determining a second correlation between the second set of EMF simulation data and the optical metrology data;
determining a weighted combination of the first correlation and the second correlation; and
determining the characteristic of the optical mask based upon the weighted combination of the first correlation and the second correlation.

9. The system of claim 7, wherein the characteristic of the optical mask includes at least one of a pattern size of the optical mask, an optical property of the mask, a sidewall angle of the optical mask or a topography profile property of the optical mask.

10. The system of claim 7, further comprising obtaining of the optical metrology data including:
illuminating a grating pattern on an optical mask;
measuring zeroth-order diffraction efficiency of the grating; and
removing the higher order diffracted beams of the grating through spatial filtration.

11. The system of claim 10, wherein the grating includes a one-dimensional grating with an equal line-space ratio.

12. The system of claim 7, the at least one computing device further configured to perform actions including:
obtaining data about a pattern size of the optical mask and data about a topography of the optical mask,
wherein the determining of the characteristic includes determining at least one of a thickness of the optical mask or an optical constant of the optical mask.

13. A computer program product comprising program code stored on a computer-readable storage medium, which when executed by at least one computing device, enables the at least one computing device to implement a method of determining a characteristic of an optical mask by performing actions including:
generating a first set of electromagnetic field (EMF) simulation data about the optical mask, using a first set of simulation criteria;
determining a first correlation between optical metrology data about the optical mask and the first set of EMF simulation data using the at least one computing device; and
determining the characteristic of the optical mask based upon the first correlation between the optical metrology data and the first set of EMF simulation data.

14. The computer program product of claim 13, wherein the program code causes the at least one computing device to further perform actions including:
generating a second set of EMF simulation data for the optical mask, using a second set of simulation criteria, the second set of simulation criteria different from the first set of simulation criteria;
determining a second correlation between the second set of EMF simulation data and the optical metrology;
determining a weighted combination of the first correlation and the second correlation; and
determining the characteristic of the optical mask based upon the weighted combination of the first correlation and the second correlation.

15. The computer program product of claim 13, wherein the characteristic of the optical mask includes at least one of a pattern size of the optical mask, refractive indices or an optical property of the mask, a sidewall angle of the optical mask or a topography profile property of the optical mask.

16. The computer program product of claim 13, further comprising obtaining of the optical metrology data including:
illuminating a grating pattern on an optical mask;
measuring zeroth-order diffraction efficiency of the grating; and
removing the higher order diffracted beams of the grating through spatial filtration.

17. The computer program product of claim 16, wherein the grating includes a one-dimensional grating.

18. The computer program product of claim 16, wherein the grating includes a one-dimensional grating having an equal line-space ratio.

19. The computer program product of claim 16, wherein the grating includes a two-dimensional grating.

20. The computer program product of claim 13, wherein the program code causes the at least one computing device to further perform actions including:
obtaining data about a pattern size of the optical mask and data about a topography of the optical mask,
wherein the determining of the characteristic includes determining at least one of a thickness of the optical mask or an optical constant of the optical mask.
